(19) United States
(12) Patent Application Publication
(10) Pub. No.: US 2020/0281185 A1
(43) Pub. Date: Sep. 10, 2020

(54) DISCHARGE UNIT FOR DISCHARGING A FINAL LIQUID HAVING A DEFINED MIXING RATIO

(71) Applicant: Robert Bosch GmbH, Stuttgart (DE)

(72) Inventors: Hans-Arndt Freudigmann, Tuebingen (DE); Jochen Glasbrenner, Stuttgart (DE); Olaf Ohlhafer, Erligheim (DE); Oliver Meil, Schwieberdingen (DE); Bernd Stuke, Leonberg (DE); Helmut Schomburg, Deufringen (DE)

(21) Appl. No.: 16/626,098

(22) PCT Filed: Jun. 11, 2018
(86) PCT No.: PCT/EP2018/065352

§ 371 Date: Dec. 23, 2019

(30) Foreign Application Priority Data
Jun. 27, 2017 (DE) 10 2017 210 777.4

(51) Int. Cl. A01M 7/00; B01F 3/08; B05B 7/32; B05B 1/20; B05B 9/04

(52) U.S. Cl. CPC A01M 7/0092; B01F 3/088; B05B 7/32; B01F 2013/1052; B05B 9/0406; B01F 2003/0896; B05B 1/20

(57) ABSTRACT

The invention relates to a discharge unit (10″) for discharging a final liquid having a defined final mixing ratio, in particular for agricultural purposes, having a first pre-mixing unit (12), which is designed to mix a first liquid with a first carrier liquid, in particular water, to form a first pre-diluted liquid having a first defined pre-mixing ratio, a second pre-mixing unit (14), which is designed to mix a second liquid with a second carrier liquid, in particular water, to form a second pre-diluted liquid having a second defined pre-mixing ratio, and a final mixing unit (20), which is designed to mix the first pre-diluted liquid with the second pre-diluted liquid to form the final liquid to be discharged having a defined final mixing ratio.

### BACKGROUND OF THE INVENTION

The invention relates to a discharge unit for discharging a final liquid, and to a method for discharging the final liquid.

DE 10 2004 047 585 A1 has disclosed an active substance supply system for a spraying device for spraying liquids, in particular for agricultural purposes, having a carrier liquid tank, a carrier liquid pump, multiple spray nozzles and a carrier liquid line for connecting the carrier liquid tank, the carrier liquid pump and the spray nozzles. In this case, provision is made of a pre-diluting pump which is able to be connected firstly to the carrier liquid tank and secondly to an active substance storage container and which is able to be operated for producing a carrier liquid-active substance mixture having a defined composition.

### SUMMARY OF THE INVENTION

The present invention relates to a discharge unit for discharging a final liquid having a defined final mixing ratio, in particular for agricultural purposes, having
a first pre-mixing unit, which is designed to mix a first liquid with a first carrier liquid, in particular water, to form a first pre-diluted liquid having a first defined pre-mixing ratio,
a second pre-mixing unit, which is designed to mix a second liquid with a second carrier liquid, in particular water, to form a second pre-diluted liquid having a second defined pre-mixing ratio, and
a final mixing unit, which is designed to mix the first pre-diluted liquid with the second pre-diluted liquid to form the final liquid for discharge having the defined final mixing ratio.

The present invention also relates to a method for discharging a final liquid having a defined final mixing ratio. The present invention furthermore relates to a computer program, a machine-readable storage medium and a control device for carrying out the method.

In the context of the present invention, a discharge unit may be understood as meaning a unit by means of which a liquid, in particular a liquid comprising a crop protection agent or a fertilizer, is able to be discharged. The discharge unit may for example be a crop protection device or a spraying device. The discharge unit may have one or more discharge elements for discharging the liquid. The discharge element may for example be a nozzle element, in particular a spray nozzle. It is conceivable that the discharge unit discharges the liquid as a liquid jet or as a spray. The discharge unit may be arranged on an agricultural work machine. Here, the discharge unit may be fitted on a hydraulic apparatus of the agricultural work machine. It is also conceivable that the discharge unit is mounted on a loading surface of the agricultural work machine. Alternatively, the discharge unit may be attached to the agricultural work machine. The agricultural work machine may be an agricultural utility vehicle, such as for example a tractor or a self-propelled sprayer. A discharge system having the discharge unit may for example be a field sprayer.

In the context of the present invention, an agricultural purpose may be understood as meaning a purpose which is directed toward economic cultivation of crop plants.

In the context of the present invention, a liquid may be understood as meaning a liquid comprising an active substance or a preparation. The active substance is an active constituent of the liquid. For example, the active substance or the preparation may be a pesticide, a fungicide or a herbicide. The active substance may be a solid or granules. The liquid may thus be a crop protection agent or fertilizer. In particular, the liquid may be a concentrate of a crop protection agent or fertilizer.

In the context of the present invention, a carrier liquid may be understood as meaning a liquid which is designed to be mixed with a crop protection agent or fertilizer so as to allow a discharge of the crop protection agent or fertilizer, or to improve the discharge. It is conceivable that a concentrate of a crop protection agent or fertilizer is diluted with the carrier liquid. It is also conceivable that a crop protection agent or fertilizer that is present as a solid or granules is suspended in the carrier liquid. It is furthermore conceivable that a crop protection agent or fertilizer that is insoluble in the carrier liquid is emulsified in the carrier liquid. The carrier liquid is preferably water.

In the context of the present invention, a final liquid may be understood as meaning a liquid, in particular a liquid comprising a crop protection agent or a fertilizer, which is formed by means of mixing of at least two pre-diluted liquids. The final liquid is therefore a mixture or a solution of at least two liquids.

In the context of the present invention, a mixing unit may be understood as meaning a unit which is designed to mix together at least two liquids for mixing to form a mixed liquid. The mixing unit may have a stirring element for the purpose of actively mixing together the liquids for mixing. The mixing unit may have at least in each case one inlet for the liquids for mixing and at least one outlet for the mixed liquid. In this case, the mixing unit may be T-shaped. The mixing unit may for example be a mixer or a mixing valve. It is also conceivable that the mixing unit is a static mixer.

In the context of the present invention, a pre-mixing unit may be understood as meaning a mixing unit which is designed to mix a liquid with a carrier liquid, in particular water, to form a pre-diluted liquid having a defined pre-mixing ratio. In the context of the present invention, a final mixing unit may be understood as meaning a mixing unit which is designed to mix together at least two pre-diluted liquids to form a final liquid having a defined final mixing ratio.

In the context of the present invention, a mixing ratio may be understood as meaning a ratio with which at least two liquids are mixed together. The mixing ratio may specify a ratio of the volumes of the liquids mixed together. It is also conceivable that the mixing ratio specifies a ratio of masses of active substances contained in the liquids mixed together. The mixing ratio may be constant with respect to time. Alternatively, the mixing ratio may be variable with respect to time. This means, in other words, that the mixing ratio, at a first time, differs from the mixing ratio at a second time, which differs from the first time. In this case, it is conceivable that the mixing ratio changes in dependence on a predefined value. The predefined value may for example be a type or a size of a weed detected by means of a suitable sensor element. The predefined value may also be a quantity or concentration of an active substance, to be discharged per unit area or unit time, in the liquid, which quantity or concentration is predefined by an operator of the discharge unit. It is also conceivable that a first defined pre-mixing ratio for a first pre-diluted liquid differs from a second defined pre-mixing ratio for a second pre-diluted liquid. A pre-mixing ratio for a pre-diluted liquid may for example be two parts of the active substance per 100 parts of water. A final mixing ratio for the final liquid for discharge may for example be two parts of the active substance per 200 parts of water.

The discharge unit may have one or more pump units. The pump unit is designed to pump, or to pass, or to transport, a liquid from a tank for the liquid. The pump unit may be arranged at a fluid line of the discharge unit. In particular, the pump unit may be arranged at a fluid line from or to the pre-mixing unit. It is alternatively possible for the liquid to be transported, or passed, by means of the tank being subjected to the action of compressed air.

Furthermore, the discharge unit may have one or more dosing elements. The dosing element is designed to dose, or to control, a passage of a liquid from a tank for the liquid. The dosing element may for example be a throttle element, in particular a variable throttle element, a shut-off valve or a proportional valve.

By way of the discharge unit according to the invention and the method according to the invention, it is then possible to match the mixing ratio of a final liquid for discharge immediately prior to discharge of the final liquid. This allows a quick response to a changed specification, such as for example a specification for a ratio of concentrations of different active substances in the final liquid for discharge. Owing to the pre-dilution of the liquids for mixing, the viscosities of the pre-diluted liquids almost correspond to the viscosity of the carrier liquid, in particular water, whereby the defined final mixing ratio of the liquid for discharge is able to be set particularly precisely and uniformly. Furthermore, the discharge unit, in particular the liquid lines of the discharge unit, owing to the pre-dilution, have only small quantities of the non-diluted liquids, with a high concentration of active substances, after the discharge of the final liquid for discharge has ended. It is thus possible for the discharge unit to be operated in a particularly economical and environmentally friendly manner.

It is advantageous if the first pre-mixing unit and/or the second pre-mixing unit are/is fluidically connected to the final mixing unit by means of in each case one fluidic connection line. In the context of the present invention, a fluidic connection line may be understood as meaning a line which is designed to pass a fluid from a receiving region of the fluid to a discharge region of the fluid. The receiving region is in this way fluidically connected to the discharge region. The fluidic connection line may for example be a pipe, a hose, a duct or a tube. This configuration makes it possible for the liquids pre-diluted by means of the two pre-mixing units to be passed from the pre-mixing units directly to the final mixing unit.

It is also advantageous if the discharge unit has a first liquid tank for the first liquid and/or a second liquid tank for the second liquid and/or a first storage tank for the first carrier liquid and/or a second storage tank for the second carrier liquid. The liquid tank may be a tank or a container or a reservoir for a liquid. In the context of the present invention, a storage tank may be understood as meaning a container or a reservoir for a carrier liquid. The liquid tank may have a static mixer or be formed as a static mixer. This configuration makes it possible for the two liquids and the two carrier liquids to be carried along by way of the discharge unit or stored at the discharge unit.

It is furthermore advantageous if the first pre-mixing unit is connected to the first liquid tank for the first liquid and/or to the first storage tank for the first carrier liquid by means of in each case one first fluidic supply line, and/or the second pre-mixing unit is connected to the second liquid tank for the second liquid and/or to the second storage tank for the second carrier liquid by means of in each case one second fluidic supply line. In the context of the present invention, a fluidic supply line may be understood as meaning a line which is designed to pass a fluid from a tank for the fluid to a discharge region of the fluid. The tank is in this way fluidically connected to the discharge region. The fluidic supply line may for example be a pipe, a hose, a duct or a tube. This configuration makes it possible for liquids stored by means of the tanks or carried along to be passed to the pre-mixing units.

It is moreover advantageous if the first carrier liquid and the second carrier liquid are the same carrier liquid, in particular water, and the second storage tank is the first storage tank. Accordingly, the discharge unit has merely one storage tank. This configuration results in the discharge unit being able to be constructed to be particularly compact.

It is also advantageous if the discharge unit has at least one nozzle element for discharging the final liquid for discharge having the defined final mixing ratio, wherein the at least one nozzle element is fluidically connected to the final mixing unit by means of a fluidic discharge line. In the context of the present invention, a fluidic discharge line may be understood as meaning a line which is designed to pass a fluid from a receiving region of the fluid to a nozzle element. The nozzle element is in this way fluidically connected to the receiving region. The fluidic discharge line may for example be a pipe, a hose, a duct or a tube. This configuration makes it possible for the discharge unit to discharge the final liquid for discharge as a liquid jet or as a spray.

It is moreover advantageous if the final mixing unit is designed to mix the first pre-diluted liquid and the second pre-diluted liquid with a further liquid to form the final liquid for discharge having the defined final mixing ratio. It is conceivable that the further liquid is a carrier liquid. In particular, it is advantageous if the further liquid is the first carrier liquid or the second carrier liquid, in particular water, and the final mixing unit is, by means of a third fluidic supply line, fluidically connected to the first storage tank for the first carrier liquid or to the second storage tank for the second carrier liquid. The final mixing unit is designed to reduce or to increase the fraction of the first and the second pre-diluted liquid of the final liquid by increasing or reducing the fraction of the carrier liquid in the final liquid. In this case, a volume flow of the final liquid for discharge can be kept constant. This configuration makes it possible for the defined pre-mixing ratios of the first and the second pre-diluted liquid to be matched by means of the final mixing unit, or for the volume flow of the final liquid for discharge to be controlled.

Advantageously, the discharge unit has one or more dosing elements. The dosing element is designed to dose, or to control, a passage of the liquids in the discharge unit. The dosing element may for example be a throttle element, in particular a variable throttle element, a proportional valve, a 2/2 valve, a 2/3 valve or a combination of the stated dosing elements. It is in particular conceivable that, by means of a 2/3 valve or two 2/2 valves arranged in parallel, at least one of the liquids, in particular the further liquid, is able to be dosed in discrete steps. The 2/3 valve has the switching positions “closed”, “semi-open”, “open”. The two 2/2 valves arranged in parallel have the switching positions “both valves closed”, “one valve open, one valve closed” and “both valves open”. The further liquid, in particular a carrier liquid, can in this way be dosed in a discrete manner in three steps. The dosing element may be arranged at one or more of the fluidic lines.

### BRIEF DESCRIPTION OF THE DRAWINGS

The invention will be described in more detail below by way of example on the basis of the appended drawings, in which:

FIG. 1 shows a schematic illustration of a first exemplary embodiment of the discharge unit;

FIG. 2 shows a schematic illustration of a second exemplary embodiment of the discharge unit;

FIG. 3 shows a schematic illustration of a third exemplary embodiment of the discharge unit;

FIG. 4 shows a schematic illustration of a fourth exemplary embodiment of the discharge unit;

FIG. 5 shows a flow diagram of a method for discharging a final liquid.

### DETAILED DESCRIPTION

In the following description of preferred exemplary embodiments of the present invention, use will be made of identical or similar reference signs for the elements of similar action illustrated in the various figures, wherein a repeated description of the elements is not given.

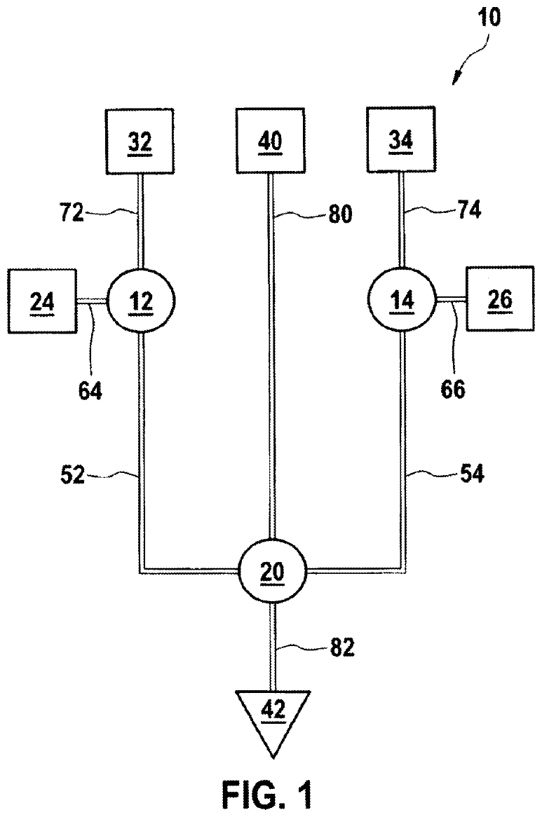

FIG. 1 shows a schematic illustration of a discharge unit for discharging a final liquid having a defined final mixing ratio. The discharge unit is denoted as a whole by the reference sign 10.

The discharge unit 10 has a first pre-mixing unit 12, a second pre-mixing unit 14 and a final mixing unit 20. The discharge unit 10 also has a first liquid tank 24 having a first liquid, a second liquid tank 26 having a second liquid, a first storage tank 32 having a first carrier liquid, a second storage tank 34 having a second carrier liquid, and a further storage tank 40 having a further liquid.

The first pre-mixing unit 12 is, by means of a fluidic supply line 64, fluidically connected to the first liquid tank 24 having the first liquid. The first pre-mixing unit 12 is, by means of a fluidic supply line 72, fluidically connected to the first storage tank 32 having the first carrier liquid. The first pre-mixing unit 12 is thus designed to mix the first liquid with the first carrier liquid to form a first pre-diluted liquid having a first defined pre-mixing ratio.

In each case one pump unit (not illustrated) is arranged at the fluidic supply lines 64, 72 so as to pump, or to pass, the first liquid from the first liquid tank 24 having the first liquid and the first carrier liquid from the first storage tank 32 having the first carrier liquid to the first pre-mixing unit 12.

In each case one dosing element (not illustrated) is arranged at the fluidic supply lines 64, 72 so as to dose, or to control, a passage of the first liquid from the first liquid tank 24 having the first liquid, and a passage of the first carrier liquid from the first storage tank 32 having the first carrier liquid, to the first pre-mixing unit 12.

The second pre-mixing unit 14 is, by means of a fluidic supply line 66, fluidically connected to the second liquid tank 26 having the second liquid. The second pre-mixing unit 14 is, by means of a fluidic supply line 74, fluidically connected to the second storage tank 34 having the second carrier liquid. The second pre-mixing unit 14 is thus designed to mix the second liquid with the second carrier liquid to form a second pre-diluted liquid having a second defined pre-mixing ratio.

In each case one pump unit (not illustrated) is arranged at the fluidic supply lines 66, 74 so as to pump, or to pass, the second liquid from the second liquid tank 26 having the second liquid and the second carrier liquid from the second storage tank 34 having the second carrier liquid to the second pre-mixing unit 14.

In each case one dosing element (not illustrated) is arranged at the fluidic supply lines 66, 74 so as to dose, or to control, a passage of the second liquid from the second liquid tank 26 having the second liquid, and a passage of the second carrier liquid from the second storage tank 34 having the second carrier liquid, to the second pre-mixing unit 14.

The first pre-mixing unit 12 is, by means of a fluidic connection line 52, fluidically connected to the final mixing unit 20. The second pre-mixing unit 14 is, by means of a fluidic connection line 54, fluidicially connected to the final mixing unit 20. The final mixing unit 20 is thus designed to mix the first pre-diluted liquid with the second pre-diluted liquid to form the final liquid for discharge having the defined final mixing ratio.

In each case one dosing element (not illustrated) is arranged at the fluidic connection lines 52, 54 so as to dose, or to control, a passage of the first pre-diluted liquid from the first pre-mixing unit 12, or a passage of the second pre-diluted liquid from the second pre-mixing unit 14, to the final mixing unit 20.

The final mixing unit 20 is, by means of a further fluidic supply line 80, fluidically connected to the further storage tank 40 having the further liquid. Through this configuration, the final mixing unit 20 is designed to mix the first pre-diluted liquid and the second pre-diluted liquid with the further liquid to form the final liquid for discharge having the defined final mixing ratio.

A pump unit (not illustrated) is arranged at the further fluidic supply line 80 so as to pump, or to pass, the further liquid from the storage tank 40 having the further liquid to the final mixing unit 20.

Furthermore, a dosing element (not illustrated) is arranged at the fluidic supply line 80. The dosing element is designed to dose, or to control, a passage of the further liquid from the storage tank 40 having the further liquid to the final mixing unit 20.

In each case one check valve is also arranged at the fluidic connection lines 52, 54 and the fluidic supply line 80 so as to prevent flowing of a liquid from the final mixing unit 20 to the pre-mixing units 12, 14 or to the further storage tank 40 having the further liquid.

The discharge unit 10 furthermore has a nozzle element 42. The nozzle element 42 is fluidically connected to the final mixing unit 20 by means of a fluidic discharge line 82. The nozzle element 42 is designed to discharge the final liquid for discharge having the defined final mixing ratio.

A shut-off valve is arranged at the fluidic discharge line 82 so as to dose, or to control, a discharge of the final liquid by means of the nozzle element 42.

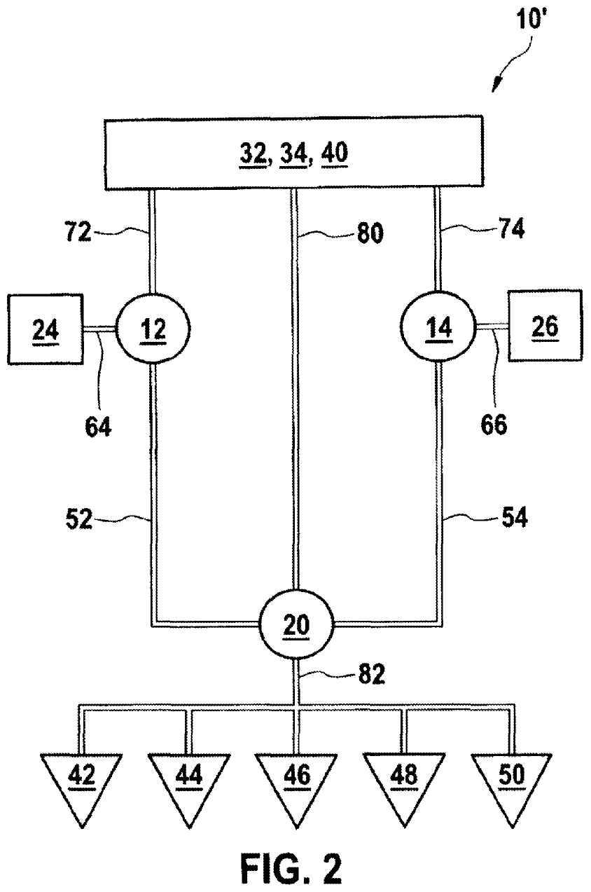

FIG. 2 shows a schematic illustration of an alternative embodiment of a discharge unit for discharging a final liquid having a defined final mixing ratio. The discharge unit is denoted as a whole by the reference sign 10′.

The discharge unit 10′ differs from the discharge unit 10 shown in FIG. 1 in that the first carrier liquid and the second carrier liquid are the same carrier liquid. Furthermore, the further liquid is the first carrier liquid. Therefore, the first pre-mixing unit 12, by means of the fluidic supply line 72, the second pre-mixing unit 14, by means of the fluidic supply line 74, and the final mixing unit 20, by means of the fluidic supply line 80, are fluidically connected to the same storage tank 32, 34, 40 having the carrier liquid.

Furthermore, the discharge unit 10′ has five nozzle elements 42, 44, 46, 48, 50. The nozzle elements 42, 44, 46, 48, 50 are fluidically connected to the final mixing unit 20 by means of the same fluidic discharge line 82. The nozzle elements 42, 44, 46, 48, 50 are designed to discharge the final liquid for discharge having the defined final mixing ratio.

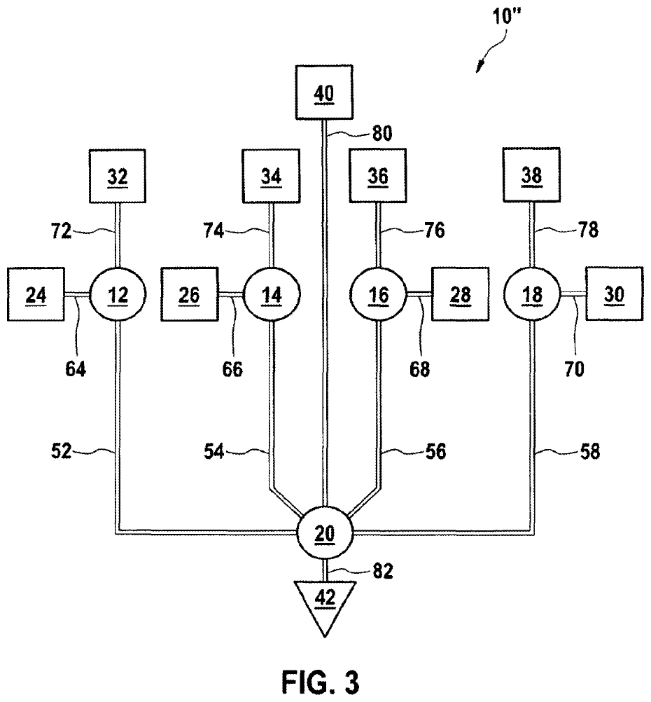

FIG. 3 shows a schematic illustration of an alternative embodiment of a discharge unit for discharging a final liquid having a defined final mixing ratio. The discharge unit is denoted as a whole by the reference sign 10″.

The discharge unit 10″ differs from the discharge unit 10 shown in FIG. 1 in that the discharge unit 10″ has a third pre-mixing unit 16 and a fourth pre-mixing unit 18. The discharge unit 10″ also has a third liquid tank 28 having a third liquid, a fourth liquid tank 30 having a fourth liquid, a third storage tank 36 having a third carrier liquid, and a fourth storage tank 38 having a fourth carrier liquid.

The third pre-mixing unit 16 is, by means of a fluidic supply line 68, fluidically connected to the third liquid tank 28 having the third liquid. The third pre-mixing unit 16 is, by means of a fluidic supply line 76, fluidically connected to the third storage tank 36 having the third carrier liquid. The third pre-mixing unit 16 is thus designed to mix the third liquid with the third carrier liquid to form a third pre-diluted liquid having a third pre-mixing ratio.

The fourth pre-mixing unit 18 is, by means of a fluidic supply line 70, connected to the fourth liquid tank 30 having the fourth liquid. The fourth pre-mixing unit 18 is, by means of a fluidic supply line 78, fluidically connected to the fourth storage tank 38 having the fourth carrier liquid. The fourth pre-mixing unit 18 is thus designed to mix the fourth liquid with the fourth carrier liquid to form a fourth liquid having a fourth pre-mixing ratio.

The third pre-mixing unit 16 is, by means of a fluidic connection line 56, fluidically connected to the final mixing unit 20. The fourth pre-mixing unit 18 is, by means of a fluidic connection line 58, fluidically connected to the final mixing unit 20. The final mixing unit 20 is thus designed to mix the first pre-diluted liquid, the second pre-diluted liquid, the third pre-diluted liquid and the fourth pre-diluted liquid with the further liquid to form the final liquid for discharge having the defined final mixing ratio.

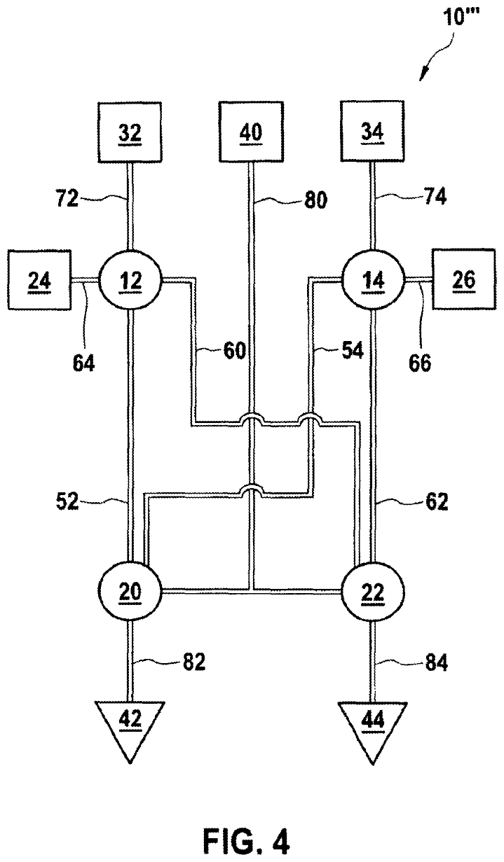

FIG. 4 shows a schematic illustration of an alternative embodiment of a discharge unit for discharging a final liquid having a defined final mixing ratio. The discharge unit is denoted as a whole by the reference sign 10′″.

The discharge unit 10′″ differs from the discharge unit 10 shown in FIG. 1 in that the discharge unit 10′ has a further final mixing unit 22.

The first pre-mixing unit 12 is, by means of the fluidic connection line 52, fluidically connected to the final mixing unit 20 and is, by means of a further fluidic connection line 60, fluidically connected to the further final mixing unit 22. The second pre-mixing unit 14 is, by means of the fluidic connection line 54, fluidically connected to the final mixing unit 20 and is, by means of a further fluidic connection line 62, fluidically connected to the further final mixing unit 22.

The final mixing units 20, 22 are, by means of the fluidic supply line 80, connected to the further storage tank 40 having the further liquid. Through this configuration, the final mixing units 20, 22 are designed to mix the first pre-diluted liquid and the second pre-diluted liquid with the further liquid to form the final liquid for discharge having the defined final mixing ratio. In this case, the defined final mixing ratio obtained by means of the final mixing unit 20 can differ from the final mixing ratio obtained by means of the further final mixing unit 22.

Furthermore, the discharge unit 10′″ has two nozzle elements 42, 44. The nozzle element 42 is fluidically connected to the final mixing unit 20 by means of the fluidic discharge line 82. The nozzle element 44 is fluidically connected to the further final mixing unit 22 by means of a fluidic discharge line 84. The nozzle element 42 is designed to discharge the final liquid for discharge having the defined final mixing ratio obtained by means of the final mixing unit 20. The nozzle element 44 is designed to discharge the final liquid for discharge having the final mixing ratio obtained by means of the further final mixing unit 22.

It is conceivable that the final mixing unit 20 and the first nozzle element 42 are arranged on a first partial width, and the further final mixing unit 22 and the second nozzle element 44 are arranged on a second partial width, of a spray boom of a field sprayer. It is also conceivable that the final mixing units 20, 22, as illustrated in FIG. 2, are each fluidically connected to multiple nozzle elements. In this case, the multiple nozzle elements are arranged on the respective partial width of the spray boom of the field sprayer, on which the corresponding final mixing unit 20, 22 is arranged.

It is furthermore conceivable that the first pre-mixing unit 12 is arranged on the first partial width, and the second pre-mixing unit 12 is arranged on the second partial width, of the spray boom of the field sprayer. In this case, it is possible for the liquid tank 24 having the first liquid to be arranged on the first partial width, and the liquid tank 26 having the second liquid to be arranged on the second partial width, of the spray boom of the field sprayer. It is also conceivable that the storage tank 32, 34, 40 having the carrier liquids are arranged on the spray boom. Alternatively, individual ones of the stated or all the stated tanks 24, 26, 32, 34, 40 may be arranged on the field sprayer outside the spray boom.

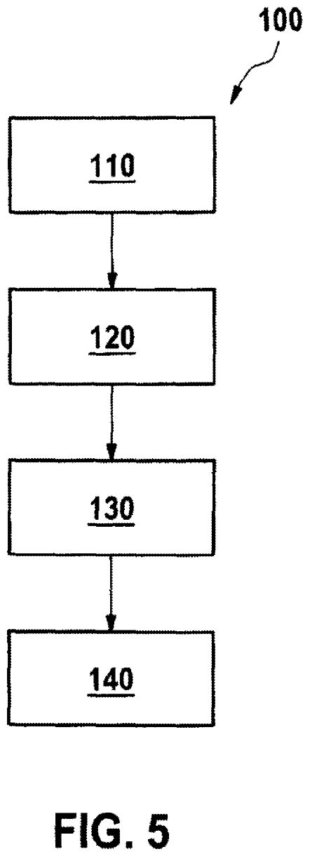

FIG. 5 shows a flow diagram of a method 100 for discharging a final liquid having a defined final mixing ratio.

In step 110, the first liquid is, by means of the first pre-mixing unit 12, mixed with the first carrier liquid to form the first pre-diluted liquid having the first defined final mixing ratio.

In step 120, the second liquid is, by means of the second pre-mixing unit 14, mixed with the second carrier liquid to form the second pre-diluted liquid having the second defined final mixing ratio.

In step 130, the first pre-diluted liquid is, by means of the final mixing unit 20, mixed with the second pre-diluted liquid to form the final liquid for discharge having the defined final mixing ratio.

In step 140, the final liquid having the defined final mixing ratio is discharged by means of the nozzle element 42.

If an exemplary embodiment comprises an “and/or” conjunction between a first feature and a second feature, this should be interpreted as meaning that the exemplary embodiment has both the first feature and the second feature according to one embodiment and has either only the first feature or only the second feature according to another embodiment.

1. A discharge unit (10; 10′; 10″; 10′″) for discharging a final liquid having a defined final mixing ratio, the discharge unit comprising:
a first pre-mixing unit (12), which is designed to mix a first liquid with a first carrier liquid to form a first pre-diluted liquid having a first defined pre-mixing ratio,
a second pre-mixing unit (14), which is designed to mix a second liquid with a second carrier liquid to form a second pre-diluted liquid having a second defined pre-mixing ratio, and
a final mixing unit (20, 22), which is designed to mix the first pre-diluted liquid with the second pre-diluted liquid to form the final liquid for discharge having the defined final mixing ratio.

2. The discharge unit (10; 10′; 10″; 10′″) as claimed in claim 1, wherein the first pre-mixing unit (12), the second pre-mixing unit (14), or both are fluidically connected to the final mixing unit (20, 22) by means of in each case one fluidic connection line (52, 54; 60, 62).

3. The discharge unit (10; 10′; 10″; 10′″) as claimed in claim 1, further comprising a first liquid tank (24) for the first liquid, a second liquid tank (26) for the second liquid, a first storage tank (32) for the first carrier liquid, or a second storage tank (34) for the second carrier liquid.

4. The discharge unit (10; 10′; 10″; 10′″) as claimed in claim 3, wherein
the first pre-mixing unit (12) is connected to the first liquid tank (24) for the first liquid, to the first storage tank (32) for the first carrier liquid, or both by means of in each case one first fluidic supply line (64, 72), and
the second pre-mixing unit (14) is connected to the second liquid tank (26) for the second liquid, to the second storage tank (34) for the second carrier, or both liquid by means of in each case one second fluidic supply line (66, 74).

5. The discharge unit (10; 10′; 10″; 10′″) as claimed in claim 1, wherein the first carrier liquid and the second carrier liquid are the same carrier liquid and the second storage tank (34) is the first storage tank (32).

6. The discharge unit (10; 10′; 10″; 10′″) as claimed in claim 1, further comprising at least one nozzle element (42, 44, 46, 48, 50) for discharging the final liquid for discharge having the defined final mixing ratio, wherein the at least one nozzle element (42, 44, 46, 48, 50) is fluidically connected to the final mixing unit (20, 22) by means of a fluidic discharge line (82, 84).

7. The discharge unit (10; 10′; 10″; 10′″) as claimed in claim 1, wherein the final mixing unit (20, 22) is designed to mix the first pre-diluted liquid and the second pre-diluted liquid with a further liquid to form the final liquid for discharge having the defined final mixing ratio.

8. The discharge unit (10; 10′; 10″; 10′″) as claimed in claim 7, wherein the further liquid is the first carrier liquid or the second carrier liquid and the final mixing unit (20, 22) is, by means of a third fluidic supply line (80), fluidically connected to the first storage tank (32) for the first carrier liquid or to the second storage tank (34) for the second carrier liquid.

9. The discharge unit (10; 10′; 10″; 10′″) as claimed in claim 1, wherein a third pre-mixing unit (16), which is designed to mix a third liquid with a third carrier liquid to form a third pre-diluted liquid having a third defined pre-mixing ratio, wherein the final mixing unit (20, 22) is designed to mix the first pre-diluted liquid with the second pre-diluted liquid, the third pre-diluted liquid and a further carrier liquid to form the final liquid for discharge having the defined final mixing ratio.

10. A discharge system, in particular mobile discharge system having a discharge unit (10; 10′; 10″; 10′″) as claimed in claim 1.

11. A method (100) for discharging a final liquid having a defined final mixing ratio, the comprising:
mixing (110), by means of a first pre-mixing unit (12), a first liquid with a first carrier liquid to form a first pre-diluted liquid having a first defined pre-mixing ratio;
mixing (120), by means of a second pre-mixing unit (14), a second liquid with a second carrier liquid to form a second pre-diluted liquid having a second defined pre-mixing ratio;
mixing (130), by means of a final mixing unit (20, 22), the first pre-diluted liquid with the second pre-diluted liquid to form the final liquid having the defined final mixing ratio; and
discharging (140), by means of a nozzle element (42, 44, 46, 48, 50), the final liquid having the defined final mixing ratio.

12. (canceled)

13. A non-transitory, computer-readable medium containing computer-readable instruction that when executed by a computer cause the computer to control a first pre-mixing unit (12), a second pre-mixing unit (14), and a final mixing unit (20, 22) to
mix (110), by means of the first pre-mixing unit (12), a first liquid with a first carrier liquid to form a first pre-diluted liquid having a first defined pre-mixing ratio;
mix (120), by means of the second pre-mixing unit (14), a second liquid with a second carrier liquid to form a second pre-diluted liquid having a second defined pre-mixing ratio; and
mix (130), by means of the final mixing unit (20, 22), the first pre-diluted liquid with the second pre-diluted liquid to form the final liquid having the defined final mixing ratio.

14. A control device which is configured to carry out the method as claimed in claim 11.
